(19) United States
(12) Patent Application Publication
(10) Pub. No.: US 2009/0060633 A1
(43) Pub. Date: Mar. 5, 2009

(54) JOINT ARRANGEMENT AND/OR BEARING ARRANGEMENT

(76) Inventors: Klaus Broker, Bohmte-Hunteburg (DE); Gerald Haukap, Ostercappeln (DE)

Correspondence Address: MCGLEW & TUTTLE, PC, P.O. BOX 9227, SCARBOROUGH STATION, SCARBOROUGH, NY, 10510-9227, US

(21) Appl. No.: 11/719,869

(22) PCT Filed: Nov. 18, 2005
(86) PCT No.: PCT/DE05/02080

§ 371 Date: Oct. 1, 2008

(30) Foreign Application Priority Data
Nov. 23, 2004 (DE) 10 2004 056 575.9

(51) Int. Cl. F16C 11/06

(52) U.S. Cl. 403/2

(57) ABSTRACT

In a joint arrangement and/or bearing arrangement (1; 101; 201; 301) to be pressed into a surrounding sleeve body, especially an edge area of a wheel carrier or spring strut, wherein the joint arrangement and/or bearing arrangement (1; 101; 201; 301) comprises a joint body (2) mobile in relation to a joint shell (4; 104; 204; 304) and a joint housing holding the joint shell (4; 104; 204; 304), at least one force-equalizing element (11, 12; 111, 112; 211, 212; 311, 312; 412; 512; 612) is provided, which keeps a force acting with a radial component on the joint housing (9) during pressing in away from the joint shell (4; 104; 204; 304) while at least a partial area (13; 14; 412a; 514; 614) undergoes deformation.

### CROSS REFERENCE TO RELATED APPLICATIONS

This application is a United States National Phase application of International Application PCT/DE2005/002080 and claims the benefit of priority under 35 U.S.C. § 119 of German Patent Application DE 10 2004 056 575.9 filed Nov. 23, 2004, the entire contents of which are incorporated herein by reference.

### FIELD OF THE INVENTION

The present invention pertains to a joint arrangement and/or bearing arrangement for being pressed into a surrounding sleeve body, especially an edge area of a wheel carrier or spring strut of chassis and/or steering parts, wherein the joint arrangement and/or bearing arrangement comprises a joint body, mobile in relation to a joint shell, and a joint housing, holding said joint shell and also pertains to a motor vehicle with one or more such joint arrangement(s) and/or bearing arrangement(s).

### BACKGROUND OF THE INVENTION

EP 0 505 719 B1 shows a joint arrangement, which has a joint body, which is spherical in some areas and which is mobile in a joint shell in the mounted state. This is secured against extraction by means of thrust collars at its axially outer ends. Such joint arrangements can be used for high requirements with radial outside tolerances of a few hundredths of one millimeter and can be pressed with strong axial forces of typically 10 to 15 kN into an outer sleeve body, e.g., an end area of a wheel carrier or a spring strut. Even if the sleeve body is manufactured with just as high a precision, there may be an overlap with a radially inwardly acting force, which is directly transmitted by the joint housing to the joint shell due to the direct contact between the joint shell and the inner wall of the joint housing. Especially if a comparatively hard and brittle high-performance plastic, for example, a PEEK plastic, which meets high requirements in terms of pressure and heat and is therefore often to be preferred to a POM plastic, which tends to flow above approx. 80 C, is used for this shell, this leads to a disadvantageous effect on the properties of the joint due, e.g., to a stronger pressing force on the joint body, which causes changes in the torque for moving the joint body and hence in the driving smoothness in a vehicle, or even ruptures or cracks in the joint shell.

### SUMMARY OF THE INVENTION

The basic object of the present invention is to avoid damage or restrictions in use due to the effect of a radially inwardly directed force during pressing in.

This object is accomplished by the present invention by means of a joint arrangement with a joint shell a joint body mounted in contact with the joint shell for movement relative thereto and a joint housing. The joint body is mounted in the joint shell that is held in the joint housing. A force-equalizing element is disposed between the joint housing and the joint shell with a portion for deforming upon the application of a pressing in force to the housing. The force-equalizing element shields the joint shell from at least a portion of a radial component of the pressing in force.

Loading of the joint shell by radial force during pressing in is avoided nearly completely by a force-equalizing element according to the present invention. The radial force is kept away from the joint shell by a deformation of at least a partial area of the force-equalizing element, so that this joint shell can remain unaffected even in case of a very brittle and thin-walled design.

Once the force-equalizing element is active during the pressing in of the joint arrangement and/or bearing arrangement into a sleeve body, excessive displacement tolerances are prevented from occurring during the ongoing operation even without exposure to external forces in the joint arrangement. The tolerance equalization, which is active during pressing in, can be made possible especially by a plastic deformability with radial introduction of the force.

The inner wall of the housing may be involved in the deformation by the deformable area pressing into the inner wall of the housing in case of exposure of the housing to a force directed radially inwardly. The deformable area may now have a high strength itself, which is especially at least as high as that of the joint shell to prevent a new weak point from being formed by the force-equalizing element.

The deformable area may be especially favorably designed now as at least one outwardly projecting ring or ring segment projection, so that this projection acts as a support on the inner wall and the rest of the force-equalizing element is not in contact over its full area with the inner wall, at least in the unloaded state, but it can slightly pivot about this support during pressing in.

The force-equalizing element is inserted between the joint housing and the joint shell and can be in contact over a large area with both the inner wall of the joint housing and the outer wall of the joint shell and keep a radially inwardly acting force away from the joint shell as a result. In particular, the force-equalizing element may surround the joint shell in a sleeve-like manner over nearly the entire length of the joint arrangement, so that the joint shell is not in direct contact anywhere with the inner wall of the joint housing. This joint housing may be designed with parallel walls without conicity on the outside, just as the sleeve body provided for receiving the completely mounted joint arrangement on the inside.

As an alternative, it is possible to provide, for instance, two force-equalizing elements located at axially spaced locations from one another, and the joint shell does not have to have any contact with the joint housing in the intermediate area even in this case to prevent the transmission of radial force from the housing into the joint shell. If there is a contact between the joint shell and the inner wall of the housing in the spacing, the joint shell may be designed as an elastic shell there and have, for example, a ring channel on the side facing the joint body as a lubricant reservoir, which channel provides a radially inwardly pointing deformation path at the same time.

Besides the plastic deformation, elastic deformation of the force-equalizing element is also possible, which also makes possible a spring force in the force-equalizing element.

A joint arrangement according to the present invention can be subjected to both rotation about the axis of the pivot in the manner of a bearing and bending and thus it can be used in a versatile manner, for instance, within chassis and/or steering parts of motor vehicles, for example, to connect spring struts or to support wheels via control arms arranged more or less at right angles in multiple-arm axles.

Other advantages and features of the present invention appear from the exemplary embodiments of the object of the present invention, which are shown in the drawings and will be described below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a longitudinal sectional view of a first embodiment of a joint according to the present invention with two force-equalizing elements, which are located axially at spaced locations from one another and are rounded towards the joint shell;

FIG. 2 is a view similar to that in FIG. 1 with two force-equalizing elements extending linearly obliquely towards the joint shell;

FIG. 3 is a view similar to that in FIG. 2 with two force-equalizing elements shaped as polygonal courses to the joint shell;

FIG. 4 is a view similar to that in FIG. 3 with two force-equalizing elements separated in a spring-like manner and by closing rings;

FIG. 5 is a view showing detail V of FIG. 3;

FIG. 6 is a view showing a detail VI of FIG. 5;

FIG. 7 is a view similar to that in FIG. 6 with the complete course of a force-equalizing element;

FIG. 8 is a view similar to that in FIG. 7 of an embodiment with an intermediate layer;

FIG. 9 is a view similar to that in FIG. 8 of an embodiment with three projecting, integrally formed rings of the force-equalizing elements; and

FIG. 10 is a view similar to that in FIG. 8 of an embodiment with a wave profile on the force-equalizing element.

### DESCRIPTION OF THE PREFERRED EMBODIMENTS

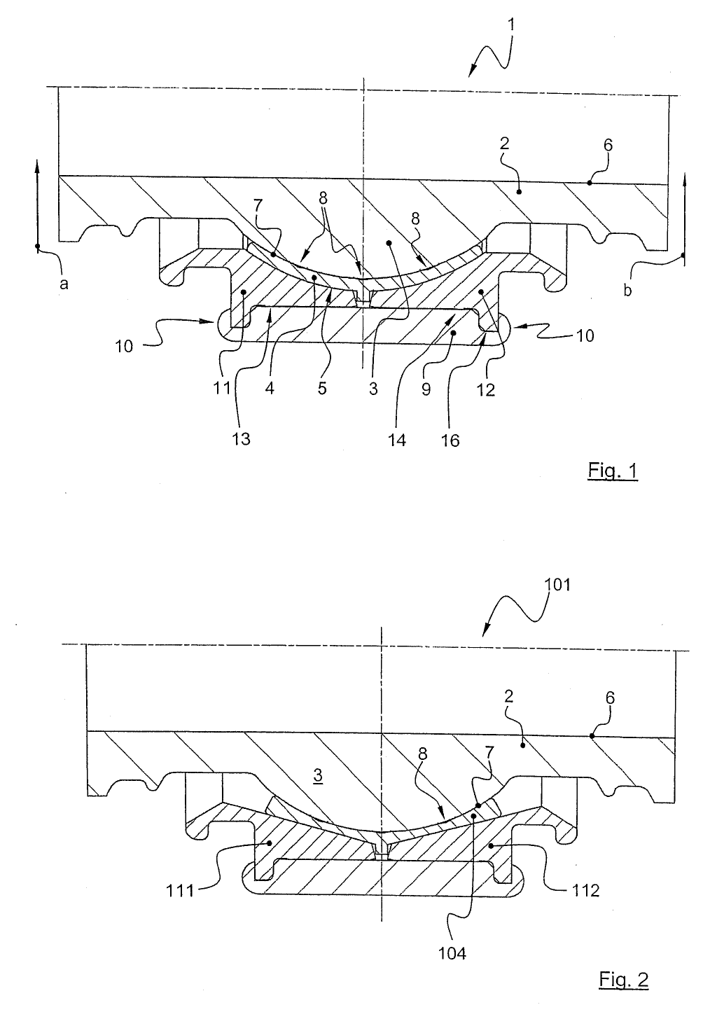

Referring to the drawings in particular, The joint arrangement 1 shown in FIG. 1 comprises an axially extended joint body 2 with an essentially spherical bulge 3 in the axially middle area. This bulge 3 is held movably in a—frequently slotted—joint shell 4, the radial outer surface 5 of the joint shell 4 according to FIG. 1 forming in the sectional view a rounding, which three-dimensionally surrounds the axis 6. The inner surface 7 of the joint shell 4 is approached in the section by a polygonal course in this example, while lubricant reservoirs 8 extending in an annular pattern are obtained in the kinks, which is not absolutely necessary. The joint shell 4 may as a whole be made of plastic to save costs and to reduce the weight, and relatively hard and brittle PEEK plastics are increasingly used to meet high pressure and temperature requirements instead of the POM plastics, which are softer but tend to flow at high temperatures.

The space between the joint body 2 and the joint shell 4 is filled here at least partly with a lubricant, which is used to reduce the friction between the contact surfaces. The lubrication may be provided especially for the entire projected service life of the joint 1.

The motion of the joint body 2 may be both a deflection in the direction of the arrows a, b and a rotation about the axis 6 of the pivot 2. Such a joint arrangement can therefore also act in the manner of a bearing and is also generally called a joint arrangement and/or bearing arrangement here.

Farther outside, the joint shell 4 is surrounded by a sleeve-like joint housing 9, whose axial ends 10 can be closed after the mounting of the joint 1, for example, by a rolling deformation. Such a joint 1 can therefore also be called as a whole a sleeve joint and pressed in a step following its mounting axially into a surrounding sleeve body—not shown here—for example, into an end area of a wheel carrier forming a through hole or into a spring strut mount with a press fit with an axial pressing force typically equaling a few to a few tens of kN. The sleeve joint 1 can be manufactured with diameter tolerances in the range of a few hundredths of one millimeter, and so can the internal dimension of the receiving sleeve body.

At least one force-equalizing element, and two force-equalizing elements 11, 12 located at spaced locations from one another according to FIG. 1, is/are arranged according to the present invention radially between the surrounding joint housing 9 and the joint shell 4 against radial stress. These are in contact with both the radially inner wall of the joint housing 9 and the outer wall of the joint shell 4. The force-equalizing elements 11, 12 are active in case of overlap between the surrounding sleeve body and the joint 1 to be pressed in and ensure that a radially inwardly acting force is kept away from the joint shell 4. As an alternative, it would also be possible that an axially continuous force-equalizing element surrounds the joint shell in a sleeve-like manner over nearly its entire length.

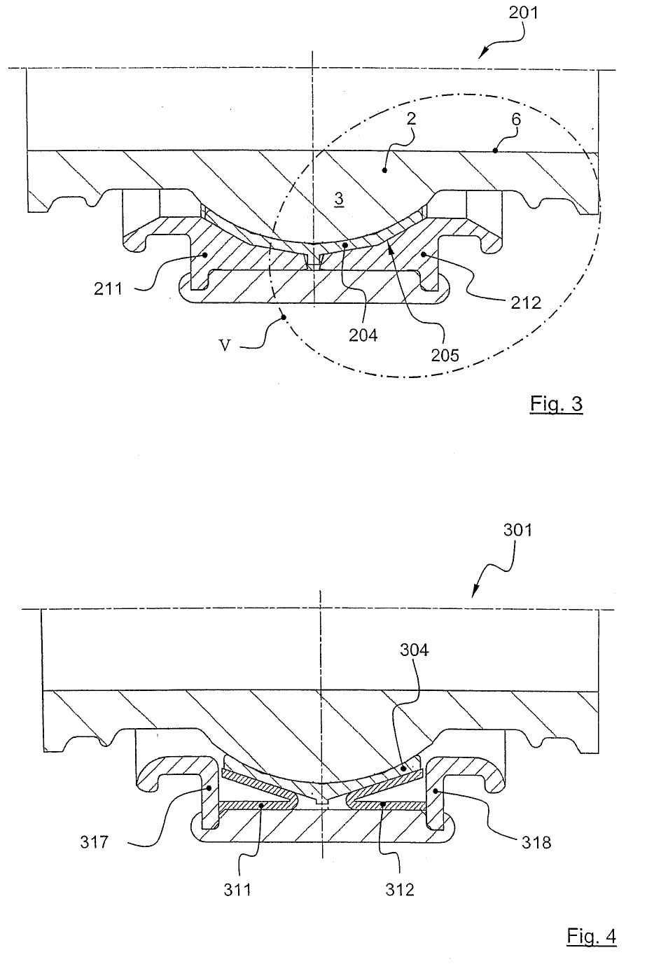

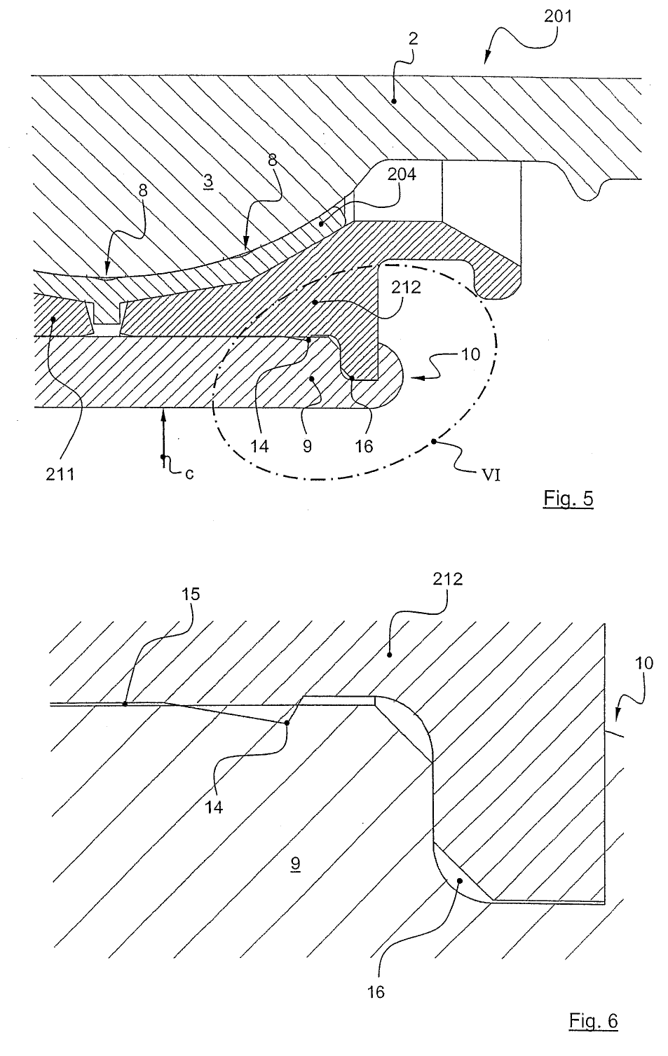

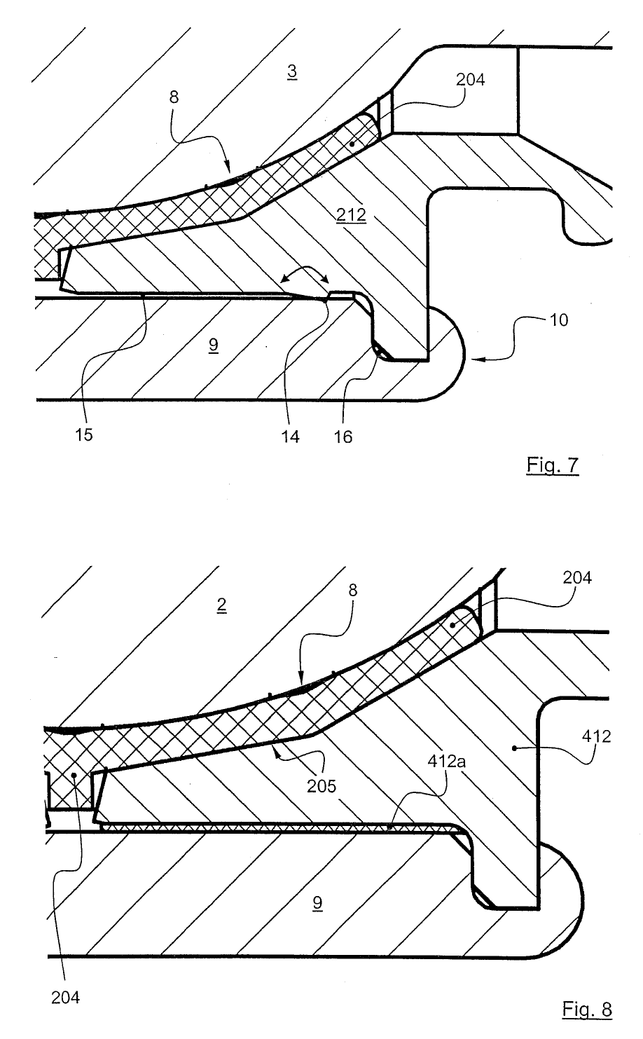

FIGS. 5 and 6 show the area 13, 14 to be deformed of the force-equalizing elements 211, 212 according to FIG. 3, which are, in principle, very similar, in a detailed form: Depending on the material selected and the material pairing, two effects may occur at different intensities in case of a force acting radially in the direction of arrow c: On the one hand, the area 14, which projects in a dog-like pattern in cross section and extends in an annular pattern, undergoes plastic or elastic deformation; on the other hand, this area 14 can dig into the inner wall of the surrounding joint housing 9, so that this housing 9 participates in the deformation. In any case, external force is kept away from the joint shell 4 located farther inwardly without any appreciable change in path. This joint shell 4 therefore remains free from deformation if the joint 1 and the sleeve body have a sufficient accuracy of fit. Therefore, the torque remains nearly independent from the overlap occurring during pressing in. The comfort and the response characteristic of, e.g., an axle equipped with joints according to the present invention are increased as a result. It becomes possible as a result to design plastic joint shells 4 as very thin-walled shells (for example, with a thickness of 0.8 mm) and with reduced amount of material used, which saves material costs, on the one hand, but, on the other hand, also brings about reduced elasticity of the material and hence leads to a steeper force-displacement curve of the joint 1. Therefore, if a weak force is introduced or if no force is introduced at all, parts 4, 2 of the joint 1 will also have no mobility as a result in the direction of the arrows a or b. The joint 1 will not flap and it can maintain its parameters very precisely even over a long-term operation. In addition, the force needed to tear out the ball is also increased as a secondary effect due to the digging in, and, moreover, there is increased sealing against the entry of water or oil. The force-equalizing elements 11, 12 can likewise remain free from deformation outside the areas 13, 14, and the gap 15 between the elements 11, 12, on the one hand, and the joint housing 9, on the other hand, can be reduced by the radial force. The areas 13, 14 now act as supports, around which the elements 11, 12 pivot in easily when radial force is introduced and act similarly to a spring.

As a result, it is ensured in case of an overlap during pressing in even after a radial load that the joint 1 will maintain the exact tolerances of the joint shell 4 and parts in the joint 1 will not show any change in path without introduction of an external force. This is ascertained during the plastic deformation of the areas 13, 14 especially when the force-equalizing elements 11, 12 have at least the strength of the joint shell 4 and therefore offer stable holding of the joint shell 4, unaffected by the pressing-in force, even outside the deformable areas 13, 14.

As can be seen in FIG. 1, the force-equalizing elements 11, 12 may be made in one piece with closing rings which bring about axial securing, mesh with grooves 16 of the joint housing 9 and are secured against being pulled out axially by the rolling of the edge areas 10. This one-piece design reduces the number of parts used.

The joint shell 104 has an outer surface extending in a straight line in the joint 101 according to a second exemplary embodiment (FIG. 2), but it is unchanged on its inner surface 7 compared to FIG. 1. The force-equalizing elements 111, 112 are also adapted only to the altered outer contour of the joint shell 4, without their function being altered.

Similar statements can also be made for a joint 201 according to a third exemplary embodiment according to FIG. 3: The outer surface 205 of the joint shell 204 likewise has a polygon-like design here, like the inner surface 7. The force-equalizing elements 211, 212 are adapted thereto.

By contrast, the joint 301 according to the other exemplary embodiment according to FIG. 4 has two lock washers as force-equalizing elements 311, 312, which are elastically deformable as a whole and do not require separate deformable areas 13, 14. They are formed here separately from the axial closing rings 317, 318. However, a one-piece design would also be possible here as an alternative. The deformation of the force-equalizing elements 311, 312 takes place here elastically and can therefore also be effective during the ongoing operation.

It is otherwise advantageous if the force-equalizing elements 11, 12, 111, 112, 211, 212 absorb radial force only during pressing in and do not perform any radial displacements, which would make the force-displacement curve of the joint flatter, during the subsequent operation.

According to another embodiment according to FIG. 8, the force-equalizing element 412 is provided with an elastically deformable intermediate layer toward the wall of the joint housing 9. Such an intermediate layer ensures that a displacement of the parts 2, 204 in the direction of the arrows a, b is also possible without introduction of an external force and therefore it makes the force-displacement curve very flat. On the other hand, the curve also remains nearly the same even over a high stress, so that the quality of the joint does not change in the process.

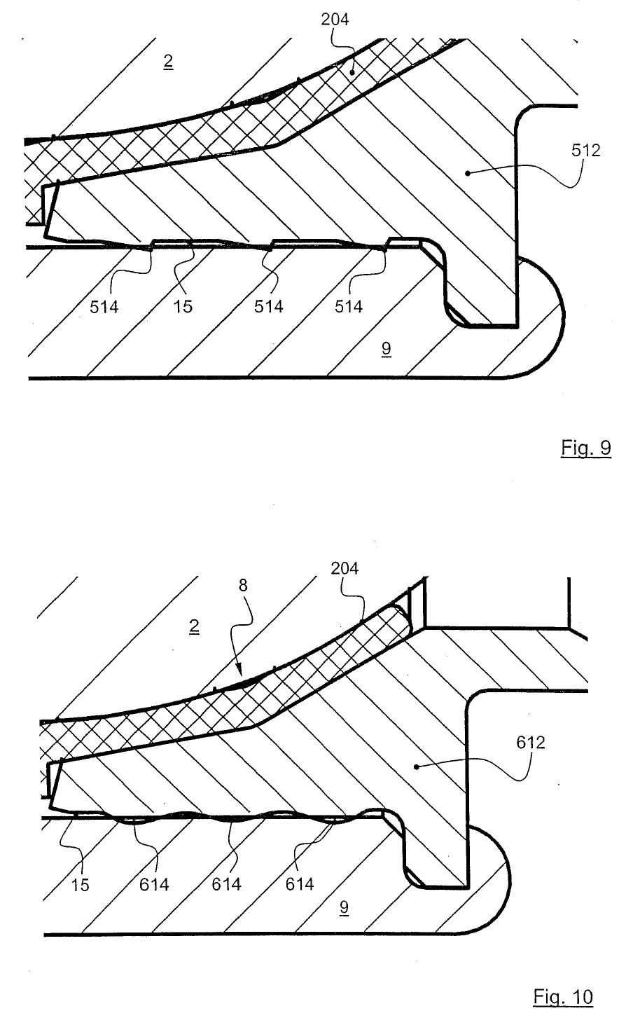

The deformable areas are again designed as bulges of the force-equalizing elements 512, 612 in the latter two exemplary embodiments according to FIGS. 9 and 10, specifically as sawtooth-like ring bulges 514 and three circumferential wave crests 614 here. These also do not have to be of equal height in every case.

In any case, as is shown here, either the joint shell 4, 104, 204, 304 has no contact with the inner wall of the surrounding joint housing 9 over its entire axial course, or it is flexible in the radially inwardly direction on a possible contact surface, not shown, e.g., due to a bead on the opposite side facing the joint body 2. A force acting radially inwardly on the joint housing 9 is therefore not restrictive in any case for the function of the joint shell 4, 104, 204, 304. This joint shell is not reduced in terms of its width and therefore it does not exert an increased pressure on the joint body 2.

While specific embodiments of the invention have been shown and described in detail to illustrate the application of the principles of the invention, it will be understood that the invention may be embodied otherwise without departing from such principles.

1. A joint arrangement and/or bearing arrangement for being pressed into a surrounding sleeve body, an edge area of a wheel carrier or a spring strut, the joint arrangement and/or bearing arrangement comprising:
a joint shell;
a joint body mobile in relation to said joint shell;
a joint housing holding said joint shell
a force-equalizing element which keeps a force acting on said joint housing with a radial component during pressing in of the joint arrangement and/or bearing arrangement into a sleeve body, away from said joint shell while at least a partial area undergoes deformation.

2. A joint arrangement and/or bearing arrangement in accordance with claim 1, wherein said force-equalizing element acts once during the pressing in of the joint arrangement and/or bearing arrangement into a sleeve body.

3. A joint arrangement and/or bearing arrangement in accordance with claim 1, wherein said force-equalizing element is in contact with both an inner wall of said joint housing and an outer wall of said joint shell.

4. A joint arrangement and/or bearing arrangement in accordance with claim 1, wherein said partial area deformable during the introduction of the radial force is plastically deformable.

5. A joint arrangement and/or bearing arrangement in accordance with claim 1, wherein said deformable area presses into the inner wall of said joint housing during the introduction of a radial force.

6. A joint arrangement and/or bearing arrangement in accordance with claim 1, wherein said deformable area is designed as an outwardly projecting ring or ring segment projection.

7. A joint arrangement and/or bearing arrangement in accordance with claim 1, wherein said deformable area is elastically deformable.

8. A joint arrangement and/or bearing arrangement in accordance with claim 7, wherein said deformable area offers a spring force against deformation of said deformable area.

9. A joint arrangement and/or bearing arrangement in accordance with claim 1, wherein said force-equalizing element surrounds said joint shell in a sleeve-like manner over nearly an entire length of said joint shell.

10. A joint arrangement and/or bearing arrangement in accordance with claim 1, further comprising another force-equalizing element to provide two force-equalizing elements, which are arranged, at axially spaced locations from one another, between said joint shell and said joint housing.

11. A joint arrangement and/or bearing arrangement in accordance with claim 10, wherein each said force-equalizing element consists of a material having a strength that is at least equal to that of said joint shell.

12. A joint arrangement and/or bearing arrangement in accordance with claim 1, wherein said joint body is subjected to both rotation about a longitudinal axis of said joint body and bending.

13. A joint arrangement and/or bearing arrangement in accordance with claim 1, wherein said joint shell includes an inner wall and an outer wall and the inner wall and the outer wall of said joint shell do not extend in parallel to one another at least in some areas and lubricant reservoirs are formed on said inner wall against said joint body.

14. A joint arrangement and/or bearing arrangement in accordance with claim 1, wherein an axial pressing-in force of said, completely mounted joint arrangement and/or bearing arrangement into a sleeve body is above 8 kN.

15. A motor vehicle comprising:
joint/bearing arrangement including a joint shell, a joint body movable in said joint shell, a joint housing holding said joint shell and a force-equalizing element for distributing a radial force, acting on said joint housing during pressing in of the joint/bearing arrangement into a sleeve body, by deformation of a portion thereof whereby said joint shell does not fully receive the radial force; and
a chassis and/or steering part including said sleeve body.

16. A joint/bearing arrangement for being pressed into a surrounding sleeve body, the joint/bearing arrangement comprising:
a joint shell;
a joint body mounted in contact with said joint shell for movement relative thereto;
a joint housing, said joint body mounted in said joint shell being held in said joint housing;
a force-equalizing element disposed between said joint housing and said joint shell with a portion for deforming upon the application of a pressing in force to said housing to shield said joint shell from at least a portion of a radial component of said pressing in force.

17. A joint arrangement and/or bearing arrangement in accordance with claim 16, wherein said force-equalizing element acts once during the pressing in of the joint arrangement and/or bearing arrangement into a sleeve body and wherein said force-equalizing element is in contact with both an inner wall of said joint housing and an outer wall of said joint shell.

18. A joint arrangement and/or bearing arrangement in accordance with claim 16, wherein said portion for deforming is plastically deformable.

19. A joint arrangement and/or bearing arrangement in accordance with claim 16, wherein said portion for deforming is elastically deformable.

20. A joint arrangement and/or bearing arrangement in accordance with claim 16, wherein said force-equalizing element surrounds said joint shell in a sleeve-like manner over nearly an entire length of said joint shell.
